(19) United States
(12) Patent Application Publication
(10) Pub. No.: US 2025/0382721 A1
(43) Pub. Date: Dec. 18, 2025

(54) SYSTEM AND METHOD FOR ENVIRONMENTALLY FRIENDLY STRIPPING VALUABLE METALS

(71) Applicant: MING CHI UNIVERSITY OF TECHNOLOGY, New Taipei City (TW)

(72) Inventor: Lo TSUI, New Taipei City (TW)

(21) Appl. No.: 18/951,755

(22) Filed: Nov. 19, 2024

(30) Foreign Application Priority Data
Jun. 18, 2024 (TW) 113122516

(51) Int. Cl. C25F 5/00; C25F 7/00

(52) U.S. Cl. CPC C25F 5/00; C25F 7/00

(57) ABSTRACT

The present disclosure provides a system for environmentally friendly stripping valuable metals, comprising an anode, a cathode, an electroplating solution and an electroplating tank; wherein the anode is a lead frame or a printed circuit board with valuable metals thereon; the anode and the cathode connected to the power supply is disposed within the electroplating tank; the electroplating solution is disposed within the electroplating tank and is a microbial liquid. The present disclosure also provides a method for environmentally friendly stripping valuable metals using the system for stripping which is powered on, wherein the valuable metals on the anode made of copper are stripped effectively after being powered on. The system and the method for environmentally friendly stripping valuable metals of the present disclosure exhibit advantageous effects including shortening stripping time for valuable metals, significantly lowering the use of chemicals, low environmental pollution, design with low complexity, recycling valuable metals with high value.

### CROSS-REFERENCE TO RELATED APPLICATIONS

This application claims the benefit of priority of Taiwan Application Number TW113122516, filed 18 Jun. 2024, which is herein incorporated by reference in its entirety.

### TECHNICAL FILED

The present disclosure relates to a system and a method for environmentally friendly stripping metals such as nickel, silver and tin on a lead frame as anode, or copper on a printed circuit board as anode, so as to maximize the retention of valuable metals on the substrate and increase the economic value of its recovery.

### BACKGROUND

Intensive scraps of lead frames containing valuable metals such as silver and tin would be produced during the semiconductor manufacturing process. For example, the top three materials mainly used in the semiconductor packaging industry include IC lead frame, gold wire, and encapsulant, wherein a lead frame is an important component for supporting chips and as a connecting media between chips and printed circuit board (PCB) circuits. A lead frame is usually a copper alloy strip pre-plated with a layer of tin or silver.

Conventionally, these scraps would usually be processed by incineration or landfill, which leads to a waste of resources and environmental pollution. Therefore, how to effectively recycle these scraps containing valuable metals become a critical issue in the art.

In the prior art, it has been tried to isolate the plating on electronic waste by pyrometallurgical smelting for dry processing, hydrometallurgy for wet processing, chemical solvents or electrochemical methods to recycle the valuable metals components plated thereon. However, these methods usually consume a large amount of chemicals and emit toxic fumes which cause secondary pollution and may only obtain valuable metals with low purity. Also, conventional techniques dissolve electronic waste made of copper in acidic or alkaline solutions. After this process, the copper is also dissolved in the solutions together and it becomes hard to recycle the copper specifically.

To reduce the use of acidic solutions, biohydrometallurgy technique is proposed. This technique utilizes microorganisms such as sulfur reducing bacteria to leach valuable metals from electronic waste, which are then adsorbed and concentrated by special microorganisms or plants. Despite that biohydrometallurgy is more environmentally friendly, it mostly requires several days of microbial extraction followed by electrochemical recovery of valuable metals, making the overall process more time-consuming and the efficiency of leaching valuable metal needs to be improved. At present, the technology is mainly at the development stage, and has not yet been realized as large-scale commercial application. In the future, it is necessary to optimize microbial strains and reaction conditions to improve the leaching efficiency and recovery speed of valuable metals.

The use of electrochemical techniques for the recovery of electronic wastes has various advantages, such as uniform deposition, simple operation, economic efficiency, and shorter operation time. However, electronic wastes usually contain a variety of valuable metals, and direct aqueous electrodeposition may lead to problems in that these metals are deposited as a mixture with each other.

Furthermore, even though a combination of electrochemistry and microorganisms has been applied to strip metals plated on electronic waste in the prior art, the microorganisms are immobilized at the anode in these techniques, which makes the process more difficult.

To solve the problem existing in prior art, the present disclosure combines environmentally friendly microorganisms and electrochemistry and utilizes microbial liquid with acidification property and high conductivity. The present disclosure dissolves and strips the plating on the lead frame or PCB as anode thereby realizing the recycle of copper with high efficiency and high purity. Also, the present disclosure may replace conventional acid electrolytes with microbial liquid composed of specific strains without several days of microbial liquid extraction, thereby significantly shortening the overall processing time needed for stripping valuable metals to 20 to 60 minutes. Accordingly, biohydrometallurgy technique of the present disclosure may reduce not only the use of chemicals, but also environmental pollution and enhance the value of recycled copper purified after stripping the plated valuable metals. The present disclosure has good application prospects in the industry.

### SUMMARY

Accordingly, the present disclosure intends to solve the problems existing in the prior art, which fails to effectively strip and recycle valuable metals in electronic scraps and wastes by combining microorganisms and electrochemistry, shortening the stripping time of process, making the scraps of lead frame or PCB reusable, be environmentally friendly and enhance the economic value.

Accordingly, in one aspect, the present disclosure provides a system for environmentally friendly stripping valuable metals, characterized by comprising:
an anode, a cathode, an electroplating solution and an electroplating tank;
wherein the anode is a lead frame or a printed circuit board with valuable metals thereon;
the anode and the cathode connected to a power supply are disposed within the electroplating tank;
the electroplating solution is disposed within the electroplating tank;
the electroplating solution is a microbial liquid.

In one embodiment, the cathode is at least one selected from a group consisting of stainless-steel sheets, nitrogen-doped carbon nanotubes (NCNTs) and platinum electrodes.

In one embodiment, the system for environmentally friendly stripping valuable metals further comprises a circulating water tank with an outlet end connected to bottom of the electroplating tank.

Accordingly, the present disclosure has the following technical features and advantages:
1. the present disclosure may strip other metals from the anode in a short period of time without several days of microbial extraction followed by recycling valuable metals by electrochemical methods;
2. compared with the complex process of fixing the microorganisms at anode in advance in prior art, the present disclosure directly uses microbial liquid as plating solution;
3. the present disclosure directly uses lead frame or a printed circuit board as anode to further improve the efficiency;
4. the present disclosure may strip valuable metals on the copper substrate of lead frame as anode, leaving the copper on the anode to enhance the value of recycled copper;
5. the present disclosure may strip valuable metals such as copper on the printed circuit board as anode thoroughly to make the printed circuit board reusable.

Further, in one embodiment, the microbial liquid comprises microorganisms containing multiple composite liquid microbial species; wherein the microorganisms contain main microorganisms with a proportion of 60% to 80% and other beneficial bacteria with a proportion of below 40%, alternatively below 20%; the main microorganisms comprise lactic acid bacteria and/or yeast and the other beneficial bacteria comprise photosynthetic bacteria and actinomycetes.

In one embodiment, the valuable metals comprise nickel, silver or tin.

In one embodiment, the valuable metals comprise copper.

In an aspect, the present disclosure also provides a method for environmentally friendly stripping valuable metals, characterized by comprising:
step1: an anode and a cathode are disposed within an electroplating tank, wherein the anode is a lead frame or a printed circuit board with valuable metals thereon;
step2: a microbial liquid is disposed within the electroplating tank after being filtered;
step3: after being powered on, the valuable metals on the anode are stripped for recycling.

In one embodiment, the anode is made of copper.

In one embodiment, a parameter of the power-on experiment in the step3 is set with a temperature of 20° C. to 80° C., preferably 20° C. to 60° C., preferably 20° C. to 40° C.

In one embodiment, a parameter of the power-on experiment in the step3 is set with a power-on time of 20 minutes to 120 minutes, preferably 20 minutes to 60 minutes, more preferably 30 minutes to 60 minutes.

In one embodiment, a parameter of the power-on experiment in the step3 is set with a current density of 0.05 ASD to 5 ASD, preferably 0.05 ASD to 1 ASD, more preferably 0.05 ASD to 0.3 ASD, even more preferably 0.1 ASD to 0.3 ASD.

In one embodiment, the valuable metal on the lead frame is at least one selected from a group consisting of zinc, chromium, cadmium, nickel, silver and tin, preferably nickel, silver and tin, more preferably tin.

In one embodiment, the valuable metal on the printed circuit board is at least one selected from a group consisting of copper, nickel, silver and gold, preferably copper.

In one embodiment, the removal rate of silver or tin of lead frame as anode after the stripping process in the step 3 is extremely high. The high removal rate of silver or tin represents the beneficial effect of high retention of copper of the anode after stripping valuable metals on the anode, thereby enhance the value of the recycled lead frame.

In one embodiment, the removal rate of copper of printed circuit board as anode after the stripping process in the step 3 is extremely high. The high removal rate of copper represents the beneficial effect of high removal of copper on the anode after stripping valuable metals on the anode, thereby enhance the value of the recycled printed circuit board.

The present disclosure applies a new system for environmentally friendly stripping valuable metals by utilizing a microbial liquid with specific composition to strip valuable metals of any lead frame or PCB as anode and directly uses the microbial liquid as plating solution, thereby realizing recycling valuable metals in electronic wastes and industrial scraps with high efficiency, high purity, and an extremely short overall processing time of only 20 minutes to 60 minutes approximately.

Furthermore, the method of the present disclosure may reduce the use of chemicals significantly without emitting toxic gases, liquids or greenhouse gases during the process, and therefore reduces environmental pollution effectively. In addition, instead of using acid to dissolve copper in liquid as in prior art, the present disclosure directly uses lead frame as anode by a new process design. Even after being stripped, the copper of lead frame is left on there instead of being dissolved. Furthermore, a printed circuit board may also be used directly as anode. After being stripped, the copper on the PCB is almost stripped to almost no copper at all. Therefore, the system and method for environmentally friendly stripping valuable metals of the present disclosure may make stripped lead frame or PCB reusable and may unexpectedly, compared with the prior art, significantly shorten the stripping time, significantly lowering the use of chemicals in process, lower environmental pollution, recycle the valuable metals with high efficiency and purity, and make lead frame or PCB as anode reusable after the valuable metals thereon are stripped.

### BRIEF DESCRIPTION OF THE DRAWINGS

FIG. 1A is the schematic diagram of the set-up of Embodiment 1 of the present disclosure; and FIG. 1B is the schematic diagram of the set-up of Embodiment 2 of the present disclosure.

FIG. 2A is a photograph of the lead frame before stripping in Examples 1 to 3 of the present disclosure; FIG. 2B shows the lead frame after stripping of Example 1 of the present disclosure; FIG. 2C shows the lead frame after stripping of Example 2 of the present disclosure; and FIG. 2D shows the lead frame after stripping of Example 3 of the present disclosure.

FIG. 3A, FIG. 3B, FIG. 3C, FIG. 3D, FIG. 3E, FIG. 3F, FIG. 3G, FIG. 3H, FIG. 3I, FIG. 3J, FIG. 3K, and FIG. 3L represent the result of SEM surface analysis of Examples 4-9, wherein FIG. 3A is the result of SEM surface analysis of the tin of Example 4; FIG. 3B is the result of SEM surface analysis of the silver of Example 4; FIG. 3C is the result of SEM surface analysis of the tin of Example 6; FIG. 3D is the result of SEM surface analysis of the silver of Example 6; FIG. 3E is the result of SEM surface analysis of the tin of Example 8; FIG. 3F is the result of SEM surface analysis of the silver of Example 8; FIG. 3G is the result of SEM surface analysis of the tin of Example 5; FIG. 3H is the result of SEM surface analysis of the silver of Example 5; FIG. 3I is the result of SEM surface analysis of the tin of Example 7; FIG. 3J is the result of SEM surface analysis of the silver of Example 7; FIG. 3K is the result of SEM surface analysis of the tin of Example 9; FIG. 3L is the result of SEM surface analysis of the silver of Example 9.

### DETAILED DESCRIPTION

The present disclosure is illustrated with drawings and embodiments in the following. It is noted that the following embodiments are merely intended to explain the content of the present disclosure, not for putting any limitation on the scope of the present disclosure.

### [Experimental Process]

In one embodiment, the experimental process of the present disclosure includes the following: first, microbial liquid is filtered to remove impurities; then, the lead frame or PCB to be processed is cut into a size suitable for the subsequent plating and stripping operation.

After being plated, the surface appearance of the plated objects is affected by current density. Generally, the smaller the current density, the smoother the surface of the plated objects; on the contrary, a more uneven shape would appear. Current density refers to the distribution of current over a certain area and is commonly measured in amperes per square decimeter (ASD). During the plating process, the plating bath is usually acidic and may corrode and dissolve the metal layer on the anode.

Accordingly, the present disclosure conducts the plating stripping at different current density, plating time, and temperatures. This is one of the core of this experiment for the sake of optimization of the efficiency and purity of metal recycling by adjusting the parameters of plating.

Last, scanning electron microscopy (SEM), energy dispersive spectroscopy (EDS) and inductively coupled plasma mass spectrometry (ICP-MS) are used to analyze the components of the products of this experiment. This would help to evaluate the performance of the plating technology used in a comprehensive manner.

[Experimental Materials]

Microbial liquid: in one embodiment, the microbial liquid used in the present disclosure is Green Life No. 1 (for example, commercially provided by ShuHuiBio company in Taiwan) which comprises microorganisms containing multiple composite liquid microbial species, wherein the microorganisms contain main microorganisms with a proportion of 60% to 80% and other beneficial bacteria with a proportion of below 40%; the main microorganisms comprise lactic acid bacteria and/or yeast and the other beneficial bacteria comprise photosynthetic bacteria and actinomycetes.

Lead frame: in one embodiment, the lead frame used in the present disclosure is provided by UWin Nanotech. Co., Ltd. in Taiwan. There are two kinds of lead frame: one is copper alloy strip plated with silver and the other is copper alloy strip plated with tin followed by being plated with silver.

Stainless steel: the stainless steel used in the present disclosure is SUS304 glossy material having a length of 7 centimeters, a width of 8 centimeters, a thickness of 0.4 millimeters with the composition shown in Table 1.

TABLE 1
composition of SUS304 stainless steel
SUS304 stainless steel composition

| Carbon % | Manganese % | Phosphorus % | Sulfur % | Silicon % | Chromium % | Nickel % |
|---|---|---|---|---|---|---|
| 0.08 | 2 | 0.045 | 0.03 | 1 | 18-20 | 8-12 |

### [Experimental Apparatus]

Power supply: a power supply with Model No. GC60-3D-WH, an operating voltage range of 0-60V, an operating current range of 0-3A.

Low-temperature thermostat water tank: a low-temperature thermostat water tank with Model No. GC60-3D-WH. The low-temperature thermostat water tank may control the temperature in a range of −20° C. to 100° C., uses microcomputer P.I.D. double subtitle to display temperature controller S.S.R. control, and has a volume of 6 L.

pH recorder: a pH recorder with Model No. PR10.

Electroplating tank: an electroplating tank with Model No. φ145×H90 mm. It is a double layer reactor with two holes for water inlet and outlet.

Inductively coupled plasma mass spectrometry: an inductively coupled plasma mass spectrometry with Model No. ICP-OES2100.

### Embodiment

### Embodiment 1: Configuration of Anode 1, Cathode 2, Electroplating Tank 3 and Power Supply 4

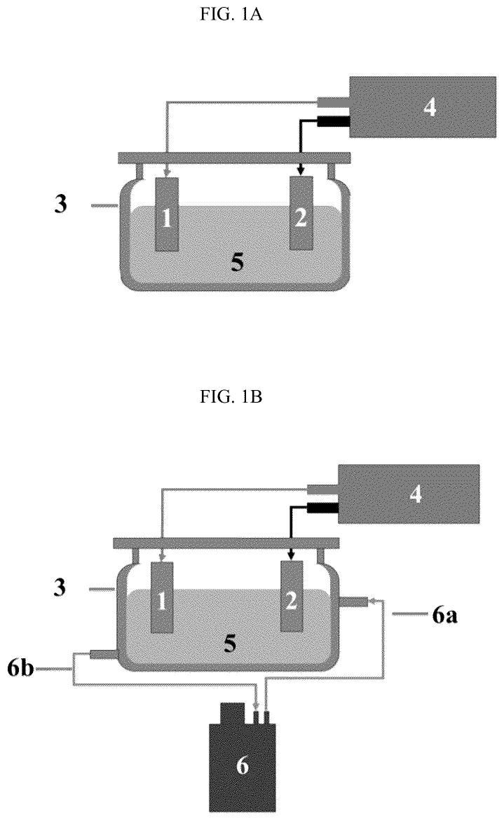

First, the filtered microbial liquid 5 was added into the electroplating tank 3 as plating solution until it filled 80% of volume of the electroplating tank 3. Then, the lead frame or PCB as anode 1 and the stainless steel as cathode 2 were placed on both sides of the glass plate in a flat manner. Next, the lead frame or PCB were connected to the anode of the power supply 4 and the stainless steel was connected to the cathode of the power supply 4, as shown in FIG. 1A.

### Embodiment 2: Configuration of Anode 1, Cathode 2, Electroplating Tank 3, Power Supply 4 and Circulating Water Tank 6

To keep the temperature steady during the process, based on the Embodiment 1, Embodiment 2 was further provided with circulating water tank 6. For Embodiment 2, first, the filtered microbial liquid 5 was added into the electroplating tank 3 as plating solution until it filled 80% of volume of the electroplating tank 3. Then, the lead frame or PCB as anode 1 and the stainless steel as cathode 2 were placed on both sides of the glass plate in a flat manner. Next, the lead frame or PCB were connected to the anode of the power supply 4 and the stainless steel was connected to the cathode of the power supply 4. Last, the circulating water tank 6 was placed below the electroplating tank 3 with the water outlet 6b of the circulating water tank 6 connected at the lower portion of the electroplating tank 3 and water inlet 6a of the circulating water tank 6 connected at the upper portion the electroplating tank 3 to keep the temperature steady, as shown in FIG. 1B.

The following example is prepared as Embodiment 2 with lead frame as anode 1 and underwent the experimental analysis related to tin and silver stripping. However, a person of ordinary skill in the art will appreciate that the valuable metals stripped may be other metals, such as copper in other examples.

### Example

[Lead Frame of Copper Plated with Silver]

The temperature of the circulating water tank 6 was fixed at 20° C. and the total plating time is 30 minutes. The current density was changed in the range of 0.1 to 0.3. The resulted products, Examples 1 to 3, were then analyzed with SEM, EDS, and ICP-MS.

TABLE 2

| | Example 1 | Example 2 | Example 3 |
|---|---|---|---|
| temperature (° C.) | 20 | 20 | 20 |
| current density | 0.1 | 0.2 | 0.3 |
| (ASD) | | | |
| Time (minutes) | 30 | 30 | 30 |

[the Analysis of the Lead Frame of Copper Plated with Silver Before and After Stripping]

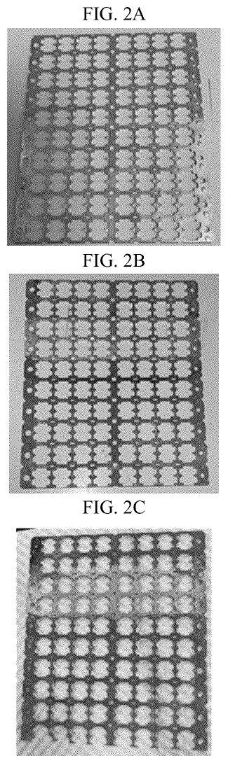

Before stripping, the lead frame is shown as in FIG. 2A. The results after stripping for Examples 1 to 3 are shown in FIG. 2A, FIG. 2B and FIG. 2C. With the current density in the range of 0.1 to 0.3 ASD, increased current density significantly improved the stripping level.

When the current density was over 0.2 ASD, the surface of the products would show strips of copper. At a current density of 0.3 ASD, the surface of the Example 3 showed intensive strips, which may result from too high stripping level. It suggested that increasing current density appropriately may significantly enhance the stripping level. However, too high current density may cause over-stripping and thus have unfavored impact on the appearance of surface of the final product. Therefore, optimized current density parameter is preferred.

[EDS Composition Analysis of the Lead Frame of Copper Plated with Silver]

TABLE 3

| | Copper (at %) | Silver (at %) |
|---|---|---|
| Example 1 | 31.72 | 1.75 |
| Example 2 | 34.14 | 0 |
| Example 3 | 39.01 | 0 |

The results of EDS composition analysis showed that increasing current density may enhance the stripping level for silver plating layer.

### [ICP-MS Liquid Composition Analysis]

TABLE 4

| | Copper (mg/L) | Silver (mg/L) |
|---|---|---|
| Example 1 | 157.9 | 0.211 |
| Example 2 | 256 | 0.137 |
| Example 3 | 295 | 0.144 |

In summary, as analyzed with EDS and ICP-MS, it was observed that silver plating layer may be stripped more easily with the effect of the microbial liquid by adjusting current density parameter. These preferred parameters were also applied as reference in the following optimization of plating process.

[Lead Frame of Copper Plated with Tin and Silver]

For the lead frame of copper plated with tin and silver, the current density was adjusted as 0.05 A/dm². Also, the temperature of the electroplating tank was changed to 20° C., 40° C., and 60° C. The plating time was 30 minutes and prolonged 60 minutes. Last, the resulted products were analyzed with SEM, EDS, and ICP-MS to evaluate the plating performance.

[SEM Analysis of the Lead Frame of Copper Plated with Tin and Silver with a Plating Time of 30 Minutes and 60 Minutes]

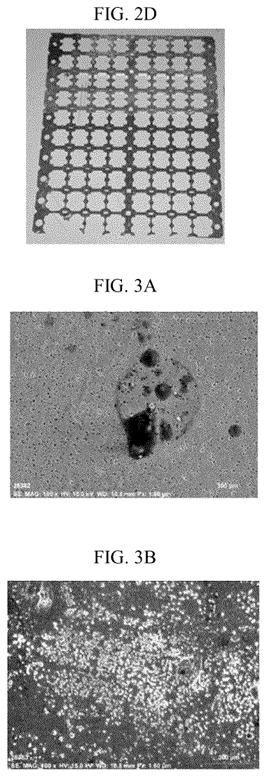

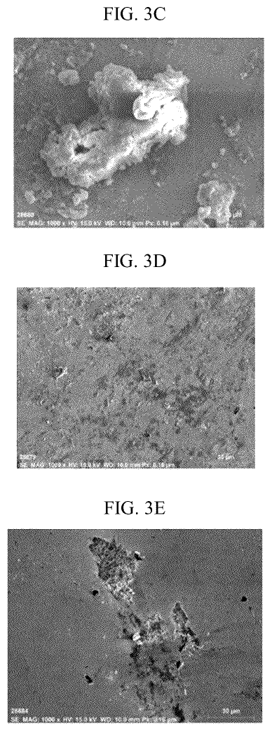

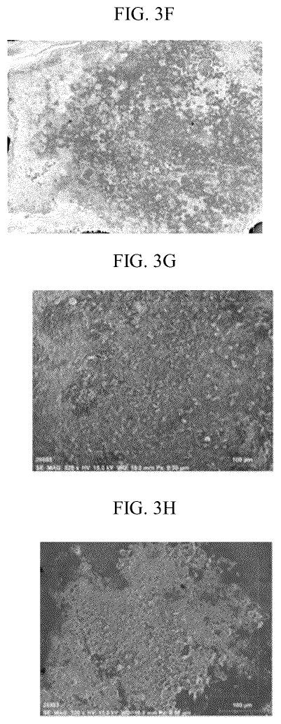

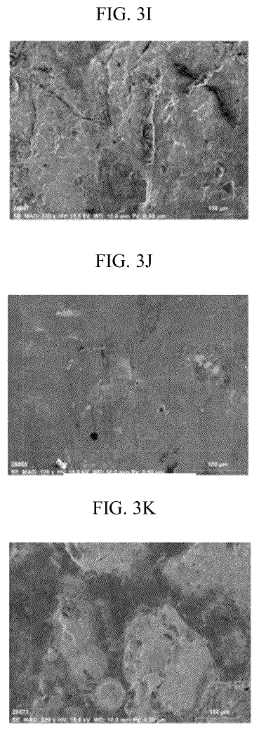

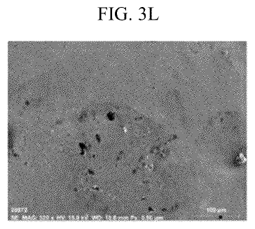

The results of SEM surface analysis of the Examples 4-9 are shown in FIG. 3A, FIG. 3B, FIG. 3C, FIG. 3D, FIG. 3E, FIG. 3F, FIG. 3G, FIG. 3H, FIG. 3I, FIG. 3J, FIG. 3K, and FIG. 3L.

With a plating time of 30 minutes, the stripping level of the tin plating layer varied as the temperature changed. As shown in FIG. 3A, for the Example 4 at 20° C., the tin plating layer started to exhibit holes, representing that it was stripped. As shown in FIG. 3C, for the Example 6 at 40° C., the tin plating layer exhibited aggregations. As shown in FIG. 3E, for the Example 8 at 60° C., the stripping level of the tin plating layer was between that of Example 4 and that of Example 6. By contrast, the silver plating layer in FIG. 3B (Example 4), FIG. 3D (Example 6), and FIG. 3F (Example 8) were only stripped at a few part thereof. However, at 30° C., the stripping level of the surface of the silver plating layer seemed to higher.

With a stripping time of 60 minutes, the tin plating layer in FIG. 3G (Example 5), FIG. 3I (Example 7), and FIG. 3K (Example 9) almost disappeared and left surfaces that were different from the surface appearance of the original tin plating layer, which mean the tin plating layers were totally stripped off. At 20° C., the silver plating layer in FIG. 3H (Example 5) exhibited more differential stripping level with the peripheral region which could be observed to had been stripped. At 40° C. (Example 7) and 60° C. (Example 9), stripping effects of the silver plating layers were relatively ambiguous. Generally, with the prolonged process time of 60 minutes, the tin plating layers were almost stripped off, while the silver plating layers showed differential stripping level at different temperatures.

[EDS Analysis of the Lead Frame of Copper Plated with Tin and Silver with a Plating Time of 30 Minutes and 60 Minutes]

With a plating time of 30 minutes, the overall stripping effect was best at a temperature of 40° C., which indicated temperature had significant impact on the stripping effect. With a plating time of 60 minutes, generally, the tin plating layers were totally stripped off, while the stripping effect of the silver plating layer was best at a temperature of 20° C. In summary, temperature would put different impact on the stripping effect with prolonged process time.

TABLE 5

| Current density | 0.05 | | | | | |
|---|---|---|---|---|---|---|
| (ASD) | | | | | | |
| Temperature | 20 | | | | | |
| (° C.) | | | | | | |
| Time (min) | 30 | | | 60 | | |
| Element (at %) | Copper | Tin | Silver | Copper | Tin | Silver |
| | 20 | 15 | 25 | 19 | 0 | 10 |
| Temperature | 40 | | | | | |
| (° C.) | | | | | | |
| Time (min) | 30 | | | 60 | | |
| Element (at %) | Copper | Tin | Silver | Copper | Tin | Silver |
| | 23 | 2 | 11 | 16 | 0.56 | 26 |
| Temperature | 60 | | | | | |
| (° C.) | | | | | | |
| Time (min) | 30 | | | 60 | | |
| Element (at %) | Copper | Tin | Silver | Copper | Tin | Silver |
| | 8 | 9 | 21 | 17 | 1.97 | 25 |

Referring to the data in Table 5, it was found that after being stripped, the proportion of copper in the lead frame based on the total amount of metal elements increased significantly at different conditions. Further, with a plating time of 60 minutes, at 20° C., the proportion of the tin plating layer decreased to 0%, while the proportion of the silver plating layer decreased to 10%, which indicated that the stripping effect was excellent at the condition of a plating time of 60 minutes and a temperature of 20° C. With a plating time of 30 minutes, at 40° C., the proportion of the tin plating layer decreased to 2%, while the proportion of the silver plating layer decreased to 11%, which indicated that the stripping effect was excellent at the condition of a plating time of 30 minutes and a temperature of 40° C.

[ICP-MS Liquid Composition Analysis with a Plating Time of 30 Minutes and 60 Minutes]

TABLE 6

| | Example 4 | | | Example 5 | | |
|---|---|---|---|---|---|---|
| Element (mg/L) | Copper | Tin | Silver | Copper | Tin | Silver |
| | 183.3 | 30.53 | 1.373 | 163.7 | 46.16 | 0.212 |
| Current density (ASD) | 0.05 | | | | | |
| Temperature (° C.) | 20 | | | | | |
| Time (min) | 30 | | | 60 | | |
| | Example 6 | | | Example 7 | | |
| Element (mg/L) | Copper | Tin | Silver | Copper | Tin | Silver |
| | 415.2 | 10.71 | 1.107 | 341.6 | 34.8 | 0.201 |
| Current density (ASD) | 0.05 | | | | | |
| Temperature (° C.) | 40 | | | | | |
| Time (min) | 30 | | | 60 | | |
| | Example 8 | | | Example 9 | | |
| Element (mg/L) | Copper | Tin | Silver | Copper | Tin | Silver |
| | 158.9 | 34.59 | 0.234 | 342 | 32.09 | 0.142 |

| Current density (ASD) | 0.05 | |
|---|---|---|
| Temperature (° C.) | 60 | |
| Time (min) | 30 | 60 |

According to the results of ICP-MS liquid composition analysis of Table 6, it was found that the content of the tin plating layer increased with prolonged process time.

The analyzed element content of the copper plating layer was maximum at 40° C. The element content of the silver plating layer was relatively steady. According to the data analysis, it was found that the stripping effect was best at the condition of a plating time of 60 minutes and a temperature of 40° C.

1. A system for environmentally friendly stripping valuable metals, comprising:
an anode, a cathode, an electroplating solution and an electroplating tank;
wherein the anode is a lead frame or a printed circuit board with valuable metals thereon;
the anode and the cathode connected to a power supply is disposed within the electroplating tank;
the electroplating solution is disposed within the electroplating tank;
the electroplating solution is a microbial liquid.

2. The system for environmentally friendly stripping valuable metals of claim 1, wherein the microbial liquid is disposed within the electroplating tank after being filtered and comprises microorganisms containing multiple composite liquid microbial species;
wherein the microorganisms contain main microorganisms with a proportion of 60% to 80% and other beneficial bacteria with a proportion of below 40%;
the main microorganisms comprise lactic acid bacteria and/or yeast and the other beneficial bacteria comprise photosynthetic bacteria and actinomycetes.

3. The system for environmentally friendly stripping valuable metals of claim 1, wherein the valuable metals comprise nickel, silver or tin.

4. The system for environmentally friendly stripping valuable metals of claim 2, wherein the valuable metals comprise nickel, silver or tin.

5. The system for environmentally friendly stripping valuable metals of claim 1, wherein the valuable metals comprise copper.

6. The system for environmentally friendly stripping valuable metals of claim 2, wherein the valuable metals comprise copper.

7. A method for environmentally friendly stripping valuable metals using the system according to claim 1, comprising:
step1: the anode and the cathode are disposed within the electroplating tank, wherein the anode is a lead frame or a printed circuit board with valuable metals thereon;
step2: the microbial liquid is disposed within the electroplating tank after being filtered;
step3: after being powered on, the valuable metals on the anode are stripped for recycling.

8. The method for environmentally friendly stripping valuable metals of claim 5, wherein the anode is made of copper.

9. The method for environmentally friendly stripping valuable metals of claim 5, wherein a parameter of the power-on experiment in the step3 is set with a temperature of 20° C. to 60° C.

10. The method for environmentally friendly stripping valuable metals of claim 5, wherein a parameter of the power-on experiment in the step3 is set with a power-on time of 20 minutes to 60 minutes.

11. The method for environmentally friendly stripping valuable metals of claim 5, wherein a parameter of the power-on experiment in the step3 is set with a current density of 0.05 ASD to 5 ASD.

12. The method for environmentally friendly stripping valuable metals of claim 5, wherein the valuable metal on the lead frame is at least one selected from a group consisting of nickel, silver and tin.

13. The method for environmentally friendly stripping valuable metals of claim 6, wherein the valuable metal on the lead frame is at least one selected from a group consisting of nickel, silver and tin.

14. The method for environmentally friendly stripping valuable metals of claim 7, wherein the valuable metal on the lead frame is at least one selected from a group consisting of nickel, silver and tin.

15. The method for environmentally friendly stripping valuable metals of claim 8, wherein the valuable metal on the lead frame is at least one selected from a group consisting of nickel, silver and tin.

16. The method for environmentally friendly stripping valuable metals of claim 9, wherein the valuable metal on the lead frame is at least one selected from a group consisting of nickel, silver and tin.

17. The method for environmentally friendly stripping valuable metals of claim 5, wherein the microbial liquid comprises microorganisms containing multiple composite liquid microbial species;
wherein the microorganisms contain main microorganisms with a proportion of 60% to 80% and other beneficial bacteria with a proportion of below 40%;
the main microorganisms comprise lactic acid bacteria and/or yeast and the other beneficial bacteria comprise photosynthetic bacteria and actinomycetes.
